(19) United States
(12) Patent Application Publication
(10) Pub. No.: US 2018/0223896 A1
(43) Pub. Date: Aug. 9, 2018

(54) END CAP DEVICE FOR BICYCLE CABLES

(71) Applicant: Yuan-Hung WEN, Chang Hua County (TW)

(72) Inventor: Yuan-Hung WEN, Chang Hua County (TW)

(21) Appl. No.: 15/860,003

(22) Filed: Jan. 2, 2018

(30) Foreign Application Priority Data
Feb. 7, 2017 (TW) 106103940

(51) Int. Cl. F16C 1/14

(52) U.S. Cl. CPC F16C 1/145

(57) ABSTRACT

An end cap device for bicycle cables is provided, including at least two tubular sleeves, each of the at least of two tubular sleeves having an opening configured to be sleeved on one of the bicycle cables, every two adjacent tubular sleeves connected by a connection section.

### BACKGROUND OF THE INVENTION

### Field of the Invention

The present invention relates to an end cap device for bicycle cables.

### Description of the Prior Art

Generally, after assembling a bicycle cable (such as a brake cable or a gear cable) to a bicycle, an end of the bicycle cable will be sleeved on an end cap to prevent the end of the bicycle cable from hurting a human body, and forming a fraying end.

However, the end cab is too small to grip by fingers in an assembly operation so that operators only can grip one end cap in the assembly operation. Thus, the assembly operation which is using the traditional end cab is time-wasting, especially in a large number of bicycle assembly. Besides, a large quantity of the end caps is hard to be stored neatly and can be scattered.

The present invention is, therefore, arisen to obviate or at least mitigate the above mentioned disadvantages.

### SUMMARY OF THE INVENTION

An object of the present invention is to provide an end cap device for bicycle cables, which is provided for operators to hold a plurality of the end caps at once, so as to easily assemble a large quantity of the end caps to the cables; besides, each of the end caps can be stored neatly and cannot be scattered.

To achieve the above and other objects, an end cap device for bicycle cables is provided, including at least two tubular sleeves, each of the at least two tubular sleeves having an opening configured to be sleeved on one of the bicycle cables, every two adjacent tubular sleeves being connected by a connection section.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIGS. 1 and 2 are perspective views of an end cap device for bicycle cables according to a preferred embodiment of the present invention;

FIGS. 3 and 4 are breakdown drawings of a preferable embodiment of the present invention;

FIG. 5 is a drawing showing a preferable embodiment of the present invention in use; and

FIG. 6 is a drawing showing a preferable embodiment of the present invention disposed on the bicycle cable.

### DETAILED DESCRIPTION OF THE PREFERRED EMBODIMENTS

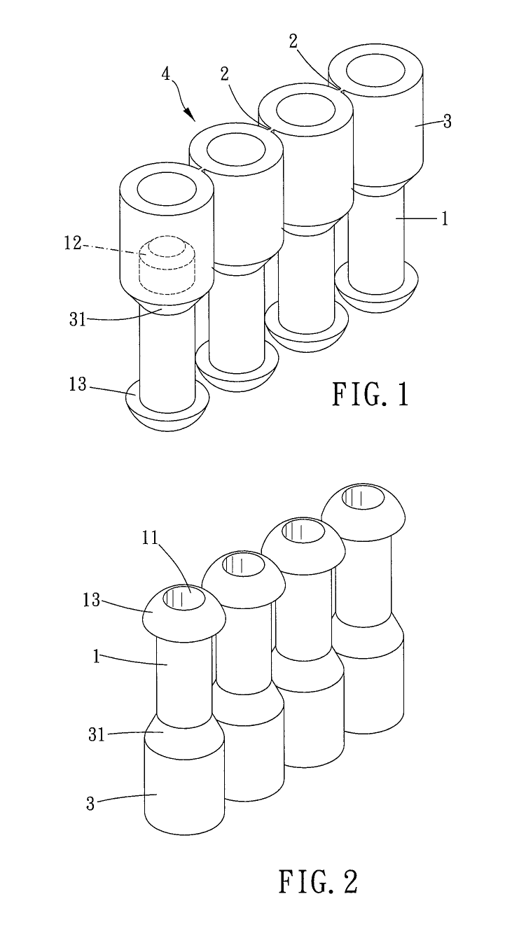

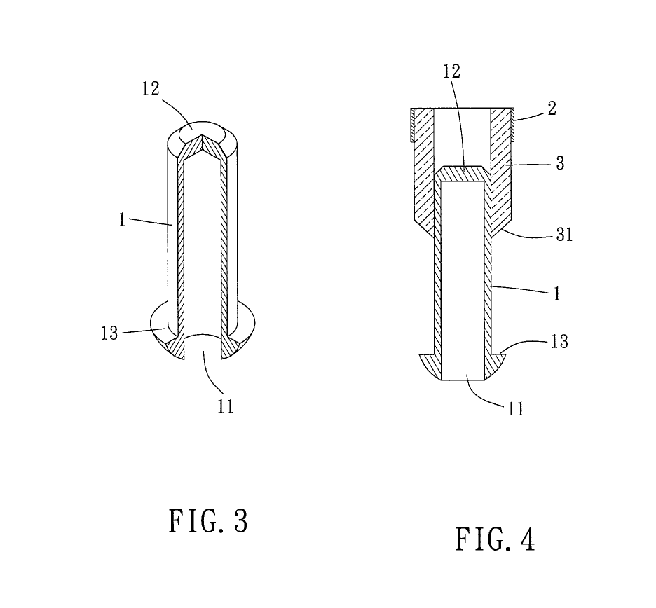

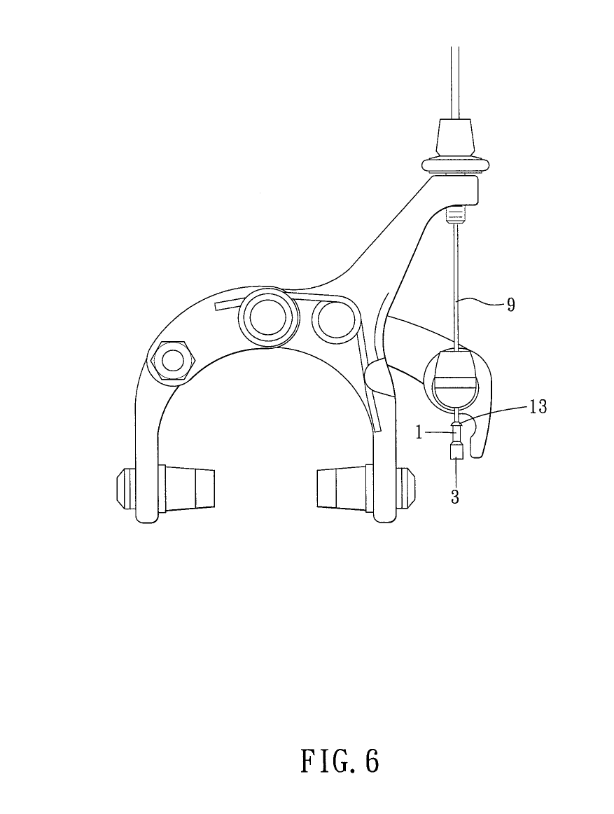

FIGS. 1 to 6 show an end cap device for bicycle cables according to a preferred embodiment of the present invention. The end cap device for bicycle cables includes at least two tubular sleeves 1.

In this embodiment, a number of the two tubular sleeves 1 is plural, each of the plurality of tubular sleeves 1 has an opening 11 configured to be sleeved on one of the bicycle cables 9, every two adjacent tubular sleeves 1 are connected by a connection section 2. In this embodiment, the bicycle cables 9 are brake cables; in other embodiments, the bicycle cables 9 can be gear cables or other control cables. Thus, every two adjacent tubular sleeves 1 are connected together by the connection section 2 for easily holding and being stored neatly without scattering.

Furthermore, the present invention can be assembled to an end cap automatic assembly system, so as to automatically assemble each of the plurality of tubular sleeves 1 to the bicycle cables 9.

Preferably, each of the plurality of tubular sleeves 1 is connected with a sleeve member 3 sleeved therearound, and every two adjacent tubular sleeves 1 and the connection section 2 connected therebetween are integrally formed of one piece, so as to easily form the connection section 2. In this embodiment, the connection section 2 is rib-shaped, adjacent of the two tubular sleeves 1 can be easily separated by cutting the connection section 2. Preferably, the sleeve member 3 is made of plastic material or rubber material, in this embodiment the sleeve member 3 is made of plastic material to reduce a production cost. Each of the plurality of tubular sleeves 1 is made of metal material so as to provide sufficient structural strength.

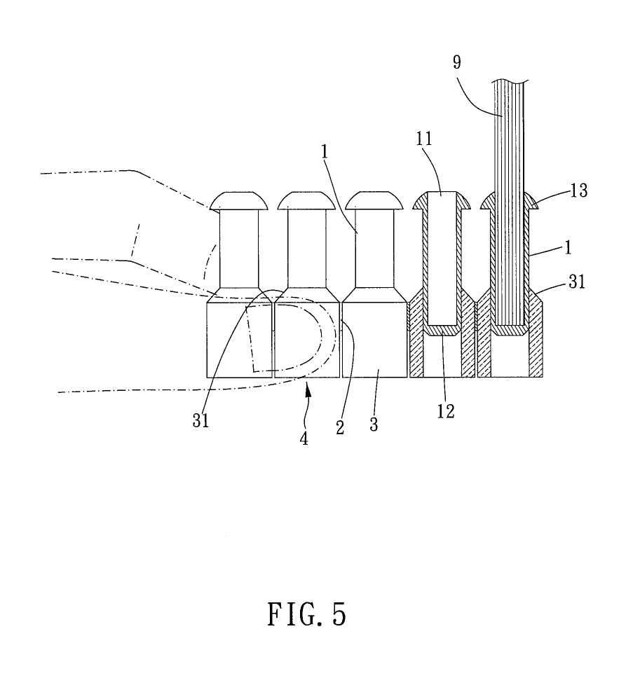

Preferably, the sleeve member 3 is sleeved on one end of each of the plurality of tubular sleeves 1 which is far away from the opening 11, so as to form a grip portion 4 for fingers (as shown in FIG. 5). Thereby, the grip portion 4 is easy for the fingers to grip to sleeve one of the plurality tubular sleeves 1 on one of the bicycle cables 9.

Wherein, one end of the sleeve member 3 which is towards the opening 11 has a taper section 31 which tapers off towards the opening 11, so as to sleeve around one of the plurality of tubular sleeves 1 tightly. One end of each of the plurality of tubular sleeves 1 which is far away from the opening 11 is a closed end 12, so as to prevent the bicycle cables 9 from passing through the tubular sleeves 1. Preferably, each of the plurality of tubular sleeves 1 has a flange 13 which extends radially and is close to the opening 11. One side of the flange 13 which is towards the opening 11 is an arc umbrella-shaped, to prevent the human body from being stab by one end of each tubular sleeves 1 which is near the opening 11.

Given the above, the end cap device for bicycle cables of the present invention, every two adjacent tubular sleeves are connected by the connection section for being gripped easily and stored in order without scattering. In addition, the sleeve member is sleeved around one of one end of tubular sleeves which is far away from the opening so as to form a grip portion for the fingers to sleeve one of the tubular sleeves on one of the bicycle cables.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. End cap device for bicycle cables, including:
at least two tubular sleeves, each of the at least of two tubular sleeves having an opening configured to be sleeved on one of the bicycle cables, every two adjacent tubular sleeves being connected by a connection section.

2. The end cap device for bicycle cables of claim 1, wherein each of the at least two tubular sleeves is connected with a sleeve member sleeved therearound, and every two adjacent tubular sleeves and the connection section connected therebetween are integrally formed of one piece.

3. The end cap device for bicycle cables of claim 2, wherein the sleeve member is sleeved on one end of the tubular sleeve which is far away from the opening, so as to form a grip portion for fingers.

4. The end cap device for bicycle cables of claim 2, wherein the sleeve member is made of plastic material or rubber material, and each of the at least two tubular sleeves is made of metal material.

5. The end cap device for bicycle cables of claim 2, wherein one end of the sleeve member which is towards the opening has a taper section which tapers off towards the opening.

6. The end cap device for bicycle cables of claim 1, wherein the connection section is rib-shaped.

7. The end cap device for bicycle cables of claim 1, wherein one end of each of the at least two tubular sleeves which is far away from the opening is a closed end.

8. The end cap device for bicycle cables of claim 1, wherein each of the at least two tubular sleeves has a flange which extends radially and is close to the opening.

9. The end cap device for bicycle cables of claim 8, wherein one side of the flange which is towards the opening is an arc umbrella-shaped.

10. The end cap device for bicycle cables of claim 3, wherein the sleeve member is made of plastic material or rubber material, each of the at least two tubular sleeves is made of metal material; one end of the sleeve member which is towards the opening has a taper section which tapers off to the opening; the connection section is rib-shaped; one end of each of the at least two tubular sleeves which is far away from the opening is a closed end; each of the at least two tubular sleeves has a flange which extends radially and is close to the opening; one side of the flange which is towards the opening is an arc umbrella-shaped.
